(19) United States
(12) Patent Application Publication
(10) Pub. No.: US 2007/0119130 A1
(43) Pub. Date: May 31, 2007

(54) Bag filter supporting cage member for a bag filter system, as well as method for producing the same

(75) Inventor: Ing. Günther Fliszar, Brunnenthal (AT)

Correspondence Address: MERCHANT & GOULD PC, P.O. BOX 2903, MINNEAPOLIS, MN, 55402-0903, US

(73) Assignee: Scheuch GmbH, Aurolzmünster (AT)

(21) Appl. No.: 11/598,394

(22) Filed: Nov. 13, 2006

(30) Foreign Application Priority Data
Nov. 18, 2005 (AT) A 1882/2005

(51) Int. Cl. B01D 46/00

(52) U.S. Cl. 55/379

(57) ABSTRACT

A bag filter supporting cage member for a bag filter system, includes several longitudinal rods which are connected to mutually spaced-apart rings, wherein the rings have groove-like receiving depressions which are open towards the outer side, the longitudinal rods being received and held therein.

### FIELD OF THE INVENTION

The invention relates to a bag filter supporting cage member for a bag filter system, said cage member comprising several longitudinal rods connected to mutually spaced-apart rings.

Furthermore, the invention relates to a method of producing such a cage member.

### BACKGROUND OF INVENTION

Bag filter systems for filtering air or the like gases loaded with particles are known e.g. from documents DE 19 944 057 A, DE 32 27 712 A, U.S. Pat. No. 3,747,307 A or U.S. Pat. No. 5,173,098 A. There, relatively long bag filters (e.g. having a length of 6 m) made of an air-permeable fabric or the like material which, however, retains the particles, are arranged externally of an inner supporting cage, and these bag filters are fastened in a closed filter enclosure; the air to be purified is supplied to the interior of the enclosure, whereas the interior of the bag filters is subjected to negative pressure via a suction device. In this manner, the air is sucked out of the enclosure space by passing through the bag filters, the particles depositing externally on the bag filters. The supporting cages in this case have the function of keeping the bag filters in their, e.g. generally cylindrical or prismatic, shape when the negative pressure relative to the enclosure space is produced in their interior.

Usually, the supporting cages (cf. also GB 1 532 302 A and EP 529 225 A) consist of longitudinal rods having a length corresponding to the length of the bag filters. These longitudinal rods—viewed in the supporting cage cross-section—as a rule are arranged circularly (optionally also approximately ovally, cf. U.S. Pat. No. 5,173,098 A) at regular intervals along the inner periphery of the bag filter and connected into a basket-like cage structure by rings which are provided along the rods at regular intervals of, e.g., 30 cm. With the known supporting cages, the longitudinal rods consist of round material made of steel just as the rings do, with the longitudinal rods being fixed to the outer periphery of the rings in spots by resistance welding. What is disadvantageous with this known construction is that when producing the welding connections between the longitudinal rods and the rings, exact positioning is required, wherein as a rule, the straightness of the longitudinal rods is negatively affected if the positioning is not quite exact. The longitudinal rods may also become warped due to the heat introduced during welding. A further disadvantage is that the longitudinal rods and the rings usually are made of a round material of galvanized steel, wherein during welding, the surface protection becomes damaged at the welds and adjacent the same so that the supporting cage must be galvanized again after it has been produced. Moreover, it has been shown that a comparatively large number of welds do not last, e.g. in the order of 0.1%, and it has to be considered that per supporting cage there may be, e.g. 600 welds or more, which means that on an average one fault is to be expected per supporting cage.

In order to avoid the great number of welds, it has been suggested in DE 27 51 476 A to produce supporting cage members in one part from plastics by injection molding. In detail, cage sections are injection molded which are nested at their front sides and inter-connected by snap connections. However, this production of supporting cage members of plastics also is complex, even though exact positioning of longitudinal rods is omitted. Besides, the strength of the supporting cages is not as good as desired.

What is disadvantageous with these known supporting cage constructions—as with all the other known supporting cages—in particular is also that the supporting cages for filter systems to be set up, because of the relatively complicated production (spot welding or injection molding) must at first be centrally produced and then they must be transported to the location of the filter system; however, the supporting cages or cage portions are bulky structures, resulting in large transport volumes—with much “air”. In this respect, dividing the supporting cages into cage portions (cf. WO 95/25579 A, U.S. Pat. No. 3,747,307 A and U.S. Pat. No. 5,173,098 A in addition to DE 27 51 476 A) does not improve the situation.

### SUMMARY OF INVENTION

It is now an object of the invention to provide a remedy for this situation and to propose a new construction of a bag filter supporting cage member as well as an appropriate method of production for the supporting cage member and an associated arrangement, wherein the supporting cage, optionally also a cage portion which is put together with other ones, can be finished on the location of assembly and use of the filter systems in a simple manner from the rings and rods, so that the production is simplified and, more-over, the problem of transportation is solved since merely longitudinal rods and rings, i.e. elements which are compact to package, are to be transported.

To achieve this object, according to a first aspect, the invention provides for a supporting cage member for a bag filter assembly comprising several longitudinal rods connected to mutually spaced-apart rings, wherein the rings have groove-like receiving depressions which open outwardly, and wherein the longitudinal rods are received and held in said receiving depressions.

According to a second aspect, the invention provides for a method of producing such a bag filter supporting cage member for a bag filter assembly, said supporting cage member including several longitudinal rods which are connected to mutually spaced-apart rings, the method comprising the steps that the rings at the sites, where they are to be connected to the longitudinal rods, are formed with groove-like receiving depressions that are open towards the outer side, and that the longitudinal rods are inserted and fixed in the associated receiving depressions.

By “supporting cage member” here a complete supporting cage is to be understood just as well as a cage portion being part of a supporting cage which—as is known from the prior art—is length-wise assembled with other cage portions so as to obtain the entire supporting cage of a length of, e.g., six meters. It should, however, be mentioned that according to the present invention uniform, complete supporting cages with continuous longitudinal rods can particularly advantageously be produced, since the production of the supporting cages or supporting cage members may occur on location, since the assembly can be carried out extremely simple, optionally even by hand, without requiring special tools. As a consequence, the longitudinal rods and the rings can be packed separate from each other when they are delivered so that bulky package units can be avoided. Insofar also lengths of, e.g., 6 m for the longitudinal rods are irrelevant.

As has already been mentioned, known supporting cages have to be prefabricated in production plants far from the bag filter systems to be set up and then have to be transported to the location of the bag filter systems. For this transportation, the supporting cages usually are accommodated in wooden crates or in special transport baskets. The packages have heights of up to 1.5 m, and several layers of supporting cages may be stored one on top of the other. Then the weight of, e.g., 9 layers of supporting cages, will rest on the lowermost supporting cage layer. Impact loads occurring during loading and unloading and during the transportation itself necessarily will result in a certain percentage of damage. Likewise, manipulations carried out during packing and unpacking will cause damage. With a view to extended storage times and longer routes of transportation, e.g. in case of transportation by ship, it is necessary to coat the supporting cages with a corrosion protection means, with galvanizing treatments or also a varnish coating being commonly used, apart from the fact that the supporting cages possibly have to be packed in sea chests. The high costs for packing and transportation involved therein just as the risk of a damage occurring during handling and during transportation and, possibly, the corrosion protection which mostly is not necessary for the operation in the bag filter system can be avoided by applying the technique according to the invention: a corrosion-protected semi-finished product (galvanized or copper-plated rods and rings, respectively) are delivered in compact packing units, and on location the supporting cage members or cages are assembled from the semi-finished products, shortly before the time of their installation. These semi-finished products can also be packaged at low costs in corrosion-protected manner in that it is shrink-wrapped so that—unless required for the operation of the bag filter system—the application of a corrosion protection in form of galvanizing or copper-plating can be omitted. The packaging expenditures for the transportation of the said semi-finished products are low so that the transportation will become extremely cost-effective. The packaging density (e.g. in kg/m³) increases in this manner to the twenty-fold, e.g., in comparison with supporting cages according to the prior art. Also this will result in substantially lower packaging and shipping costs. Furthermore, any risk of damage occurring during packing, transportation and unpacking is practically eliminated, since only handling of rods and rings, yet not of bulky, comparatively fragile supporting cages is required. Due to the fact that they will be assembled only after their transportation, the supporting cages can be made of longitudinal rods and rings of comparatively slight cross-sectional dimensions, since the aforementioned load thereon during transportation is omitted.

In the known supporting cages which in their finished state have to be transported to the location of the bag filter system to be set up, the cages must not damage each other when being transported, when supporting cages arranged on top weigh down on the supporting cages below them during impact loads. Therefore, a more massive construction with larger cross-sectional dimensions of the rings and longitudinal rods is required for the transportation of the supporting cages than would actually be needed for the filtering operation proper, e.g. longitudinal rods having a diameter of 3 mm would suffice for the filtering operation, yet with the known supporting cages, rod diameters of 4 mm are required because of the mechanical loads occurring during their transportation. The supporting cage according to the invention with its special connecting technique allows for a production on location, and therefore—since no transportation-caused damage of finished supporting cages need be feared—a more light-weight production, e.g. with the said rod diameters of 3 mm, can be realized.

With the prior art supporting cages, moreover, circumferential tolerances of from 1 mm to 5 mm are given on account of the different welding depths which depend both on the contact relationships during resistance welding and also on the different material relationships per coil. These tolerances have effects on the bag filters. Depending on the operational requirements, bag filters for purifying exhaust air can be classified into two qualities: the normal qualities have sufficient elasticity in order to be able to equalize the aforementioned circumferential tolerances. However, if the bag filters are to be used in a higher temperature range (150° C. to 200° C.), special materials, such as fiber glass, carbon fiber or the like, are required for their production. Yet, such bag filters have only little elasticity, and in this case they have to be tailored to the supporting cages of each charge. With the supporting cage according to the invention, however, a circumferential accuracy of 0.5 mm can be maintained because of the new connection technique between the longitudinal rods and the rings, thereby rendering such an individual adaptation unnecessary.

In the supporting cages and supporting cage members according to the invention, the longitudinal rods can be fixed in the receiving depressions by non-positive engagement or frictional fit, optionally in part also by positive engagement, in a press fit or clamping fit, optionally by snapping engagement in case of undercut receiving depressions. The longitudinal rods are simply pressed into the receiving depressions, wherein, however, optionally the rims of the receiving depressions in their entry or opening regions can be pressed to the respective longitudinal rods under plastic deformation, such as in the form of a squeezing action. Externally, the rings are designed as round as possible so as to be gentle on the bag filters slipped thereunto. In order to obtain particularly long connecting sites (viewed in axial direction) and to ensure an automatic, good positioning of the longitudinal rods on the rings, it is particularly advantageous if the rings are made of a flat material, in particular of steel or the like metal. In these rings, the groove-shaped receiving depressions are produced by crimp-type bending. In case of such flat-material rings, the upper and lower ring rims can simply be bent inwards so as to be gentle on the bag filters, i.e. to avoid the contact of the bag filters with sharp edges. Furthermore, an inclined arrangement of the longitudinal grooves in the rings has proven to be suitable for a particularly stable fixing of the longitudinal rods: the grooves, or the groove-like receiving depressions, respectively, may have a longitudinal axis transverse to the plane of the ring which is inclined by a slight angle, e.g. by 1° to 2°, to an axis-parallel line, i.e. to a supporting cage axial plane extending through the middle of the respective receiving depression. From receiving depression to receiving depression, the inclination in this case may alternately be in one direction and in the other direction.

### BRIEF DESCRIPTION OF THE DRAWINGS

In the following, the invention will be explained in more detail by way of particularly preferred exemplary embodiments to which, however, it shall not be restricted, and with reference to the drawings. In the drawings, in detail,

FIG. 1 shows a portion of a supporting cage according to the invention in a perspective view;

FIG. 2 shows a view of such a portion of a supporting cage;

FIG. 3 shows a front view of this supporting cage;

FIG. 4 shows detail IV indicated in FIG. 3, on an enlarged scale to illustrate the position of a longitudinal rod in a groove-like depression of a ring;

FIG. 5 shows a view of a ring with groove-like receiving depressions, without longitudinal rods;

FIG. 6 shows a top view onto this ring according to FIG. 5;

FIG. 7 shows the detail according to VII in FIG. 6, on an enlarged scale;

FIG. 8 shows a perspective view of such a ring with groove-like receiving depressions;

FIG. 9 shows a section through a flat material ring, such as according to line IX-IX of FIG. 6, wherein the ring is shown with inwardly bent upper and lower rims;

FIG. 10, on a scale enlarged as compared to FIG. 5, shows a view of a part of a ring, here with inclinedly positioned (interlaced) groove-like receiving depressions; and

FIGS. 11 and 12 show cross-sections through rings according to modified embodiments.

### DETAILED DESCRIPTION OF PREFERRED EMBODIMENTS

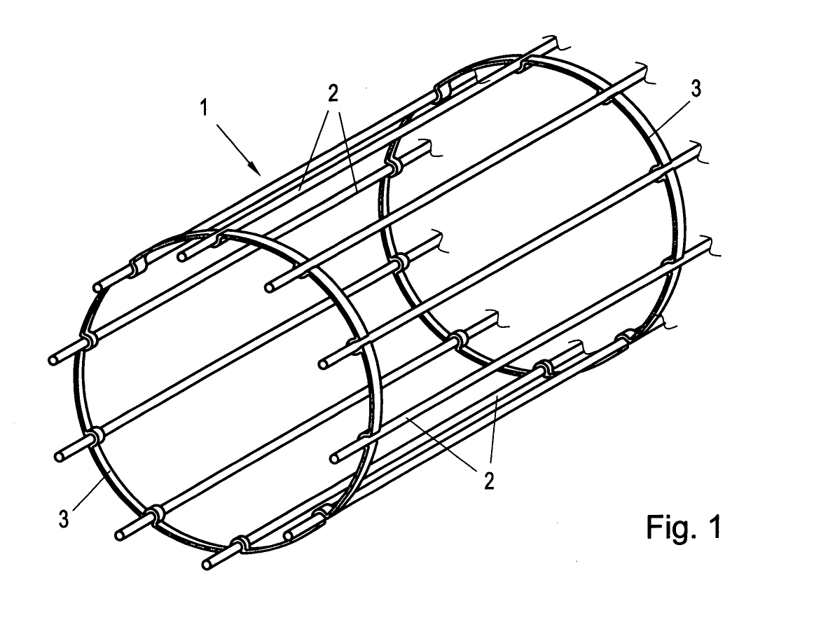

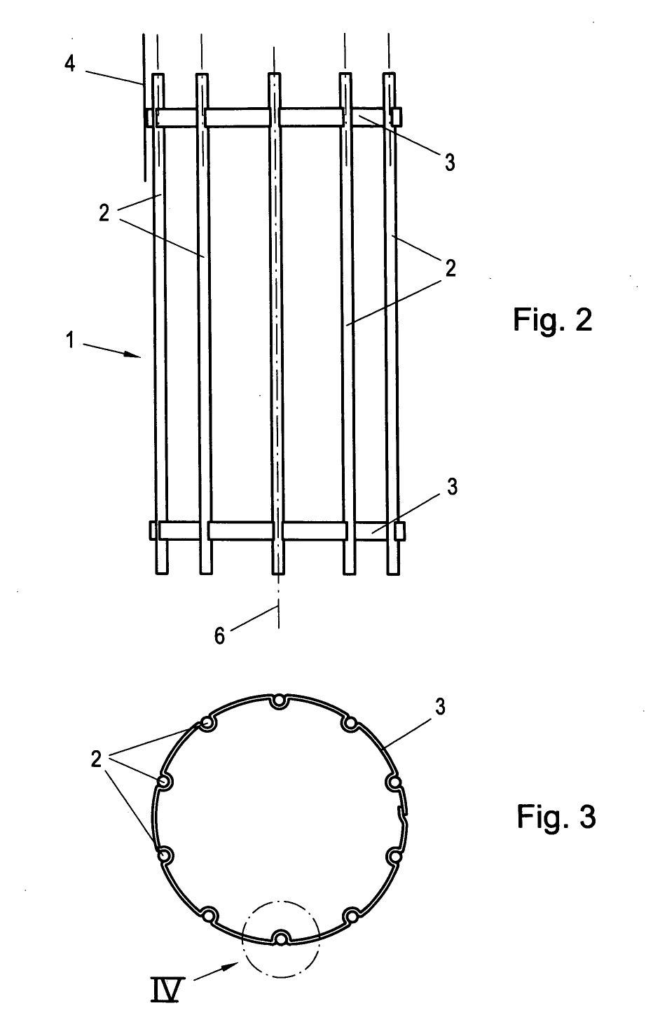

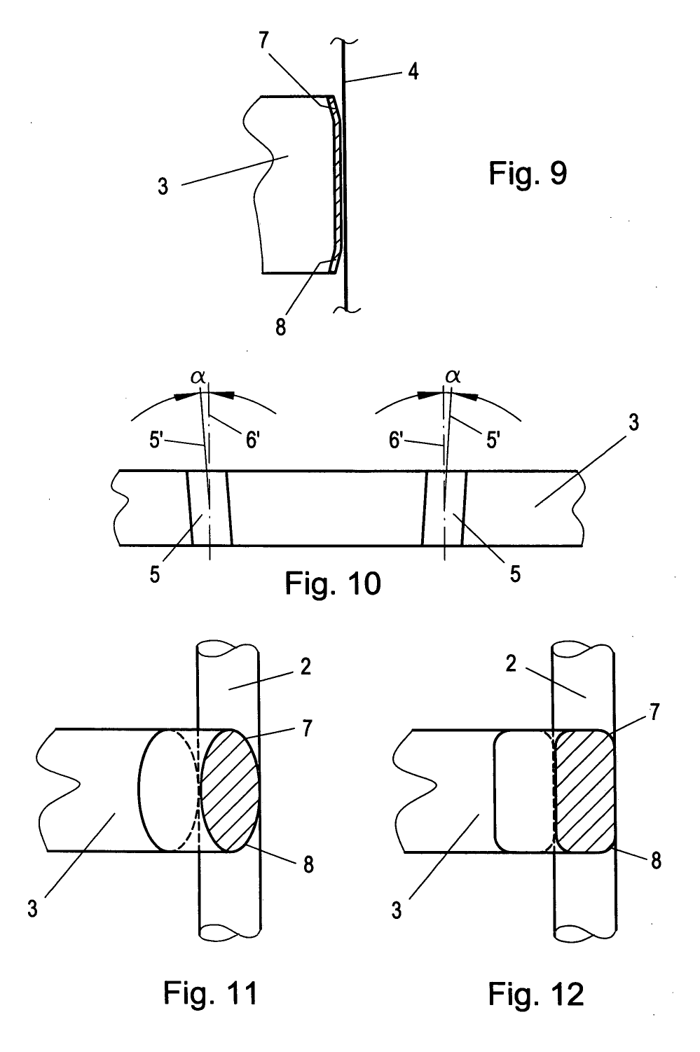

In FIG. 1, a section or part of a bag filter supporting cage or cage member 1 is shown in perspective, which is assembled of longitudinal rods 2 arranged parallel to each other, and (connecting) rings 3 arranged with the ring planes transversely to the longitudinal rods 2. On such supporting cages 1, bag filters are pulled up for the operation in bag filter systems, and in FIG. 2 (as also in FIG. 9) in a partial region such a bag filter 4 is indicated only quite schematically.

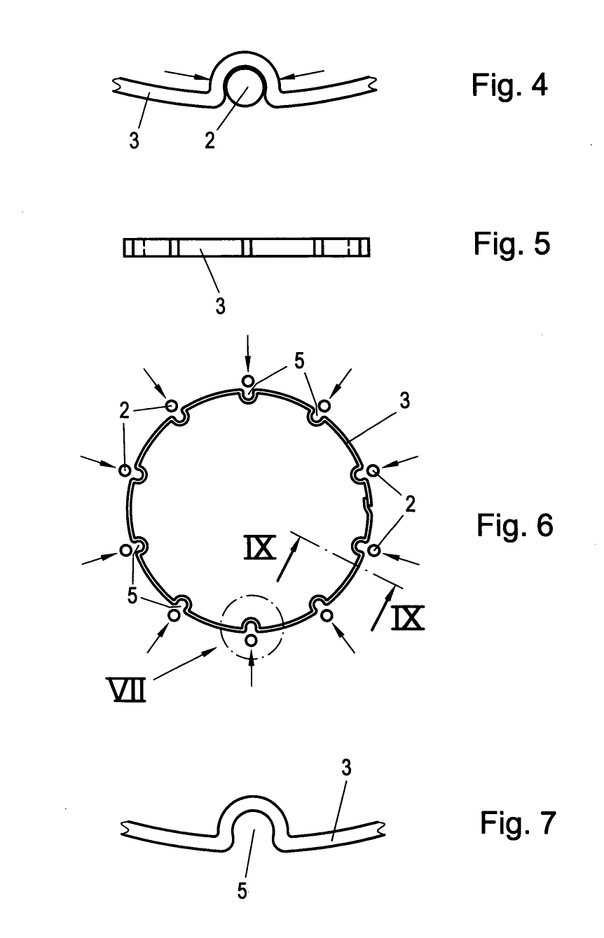

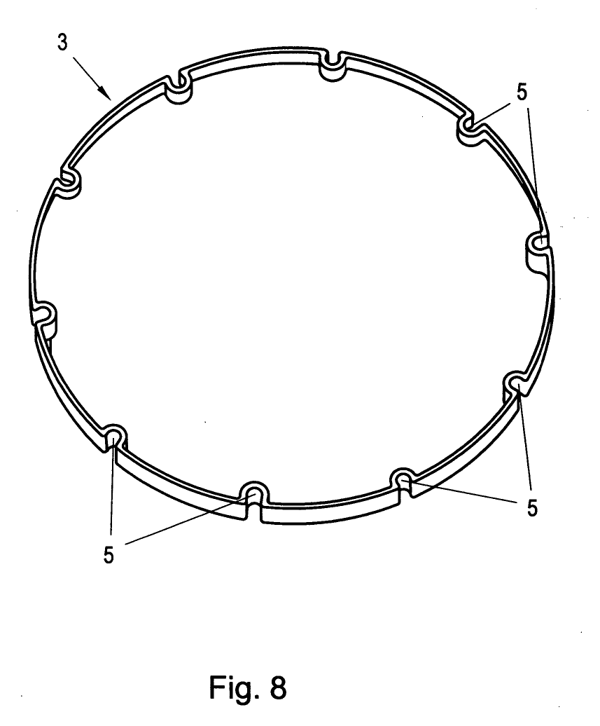

In detail, the rings 3 according to FIGS. 1 to 9 consist of a flat material, strip material or the like, having a width (height) of 10 mm, e.g.. These rings have axis-parallel groove-like receiving depressions 5 distributed over their peripheries, termed grooves 5 in short hereinafter, which grooves, e.g. in case that metal flat materials are used for the rings 3, are shaped by bending, pressing or embossing of the rings 3, cf. also FIGS. 7 and 8 in addition to FIGS. 5 and 6. These axis-parallel depressions 5 serve to receive the longitudinal rods 2, wherein the longitudinal rods 2 are simply pressed or pushed into these grooves or depressions 5 and, thus, are mechanically fixed by a press fit or clamping fit, or a snap fit, respectively, cf. FIGS. 3 and 4. In this respect, the axis-parallel grooves 5 provide for a longitudinal guiding for the longitudinal rods 2, so that a certain self-alignment of the longitudinal rods 2 in parallel to the longitudinal axis 6 (FIG. 2) of the supporting cage 1 will be obtained during the assembling of the supporting cage 1. With this longitudinal guiding and fixing of the longitudinal rods 2 in the longitudinally extending grooves 5 by frictional engagement, also a stable fastening is achieved at a relatively long connecting region (e.g. 10 mm), as compared with the spot welding in the known supporting cages.

The connection between the rings 3 and the longitudinal rods 2, which, as has been mentioned, particularly is effected by pushing, pressing, or snapping, respectively, the rods 2 into the grooves 5, optionally also by plastic deformations of the groove rim regions around the peripheral regions of the rods 2, is extremely simple to do and can be carried out without any problems also by persons with little training. Faults in making these connections are practically excluded. Furthermore, it is also advantageous that with this embodiment and production of bag filter supporting cages 1, a surface protection (corrosion protection) already present does not become damaged—the common corrosion protection (e.g. by galvanizing) easily withstands such pushing of the longitudinal rods 2 into the grooves 5 of the rings 3.

By the fact that the longitudinal rods 2 are pushed into the grooves 5, the respective flat material ring 3 thus extending according to a wider diameter than the inner side of the bottom of the grooves 5 and, thus, also than the inner side of the longitudinal rods (cf. FIGS. 3 and 4), there results a larger free air passage area compared with the inwardly arranged round material rings of the prior art, with an equally sized bag filter cross-section. On the other hand, it is advantageous that on the outer side of the rings 3, due to the fact that the longitudinal rods 2 are received in the grooves 5, a practically flush cylinder face without any projecting portions is obtained so that the hose-like bag filters 4 can be pulled up without any problems, without being locally bulged.

The construction described thus leads to a substantial reduction of the costs during the production of the supporting cages 1 and, thus, during the production of bag filter systems as a whole.

A further advantage is further to be seen in the fact that, as a consequence of the simple production of the supporting cages 1, starting from the prefabricated rings 3 of flat material, with the molded grooves 5, and with the prefabricated longitudinal rods 2, production of the supporting cages 1 on location, during setting-up of filter systems at the location of the system, is possible. On the other hand, as mentioned before, with the prior art supporting cages, a central production thereof as well as delivery to the location of the filter system was required, wherein due to the bulky supporting cages one was faced with a considerable transporting problem, considering that for one filter system, e.g., 10,000 bag filters and, accordingly, 10,000 supporting cages may be necessary. When employing the present technique, it is now possible to simply deliver the longitudinal rods and the rings as yet unconnected, whereby compact packages and small transport volumes are possible.

In addition to being made from a flat metal material, in the proposed technique the rings 3 may, e.g., also be produced as (synthetic material) injection molded parts. The rings 3, or the supporting cages 1, respectively, may have a diameter in the order of 120 to 200 mm; usually, the longitudinal rods 2 have lengths of from 4 to 6 m, and, as a rule, the rings are mounted at intervals of 30 cm from each other. In the proposed technique, the longitudinal rods 2 may also be made from a round material just as before, e.g. with a diameter of from 2 to 4 mm, in particular 3 mm.

To be gentle on the bag filters 4, the flat rings 3 may be inwardly crimped, bent or chamfered at their upper and lower rims, cf. FIG. 9, in which a cross-section of a flat material ring 3 (without grooves) having inwardly bent rims 7, 8 is shown. A portion of the bag filter 4 is also indicated in FIG. 9 (in longitudinal section).

A gentle effect on the bag filters 4 by rounded rims, or edges, respectively, of the ring 3 can also be achieved if the ring 3, in cross-section, has an appropriately rounded shape in the edge regions, such as according to FIG. 11, where a longitudinal-oval cross-sectional shape can be seen for the ring 3, or according to FIG. 12, where a more rectangular cross-section of the ring 3 is shown, yet with rounded portions in the four corner regions or edge regions. Here, too, it is essential that rounded edge regions 7, 8 are provided on the outer side.

From FIG. 10, finally, in a schematic view of a portion of a ring 3 it can be seen that, compared to axis-parallel lines or axial planes 6′ extending through the groove centers, the grooves 5 are slightly inclined with their central longitudinal axes 5′, such as by an angle α=1° to 2°. By this, an intensified clamping action or an intensified press fit of the longitudinal rods 2 in the grooves or, generally, in the receiving depressions 5 is obtained. As is further visible from FIG. 10, the inclined positions of the grooves 5 may be provided alternately in the one direction and in the other direction, to thereby also be able to use also opposite inclinations of aligned grooves 5 in neighboring rings for an intensified fixing of the longitudinal rods 2 on the rings 3.

1. A bag filter supporting cage member for a bag filter assembly comprising a plurality of longitudinal rods connected to mutually spaced-apart rings, wherein the rings have groove-like receiving depressions which open outwardly, and wherein the longitudinal rods are received and held in said receiving depressions.

2. A supporting cage member according to claim 1, wherein the longitudinal rods are maintained in the receiving depressions in a press fit.

3. A supporting cage member according to claim 1, wherein the receiving depressions have a narrowed outer mouth.

4. A supporting cage member according to claim 3, wherein the receiving depressions have, in their mouths, rims which are pressed against the longitudinal rods under deformation.

5. A supporting cage member according to claim 1, wherein the rings at least on their outer sides which are to face the bag filter are rounded on their upper and lower sides.

6. A supporting cage member according to claim 1, wherein the rings are made of a flat material in which the groove-like receiving depressions are bent out like crimps.

7. A supporting cage member according to claim 5, wherein the flat material rings are bent inwards at their upper and lower rims.

8. A supporting cage member according to claim 6, wherein the groove-like receiving depressions have a longitudinal axis transverse to the ring which is slightly inclined towards a supporting cage axial plane that extends through the middle of the respective receiving depression.

9. A supporting cage member according to claim 8, wherein the longitudinal axis of the receiving depressions is inclined under an angle of about 1° to 2°.

10. A supporting cage member according to claim 8, wherein the longitudinal axes of receiving depressions which follow each other in peripheral direction alternately are inclined in one direction and in another direction relative to the respective axial plane.

11. A method of producing a bag filter supporting cage member for a bag filter assembly, said supporting cage member including several longitudinal rods which are connected to mutually spaced-apart rings, the method comprising: the rings at the sites, where they are to be connected to the longitudinal rods, are formed with groove-like receiving depressions that are open towards the outer side, and that the longitudinal rods are inserted and fixed in the associated receiving depressions.

12. A method according to claim 11, wherein the longitudinal rods are pushed into the receiving depressions.

13. A method according to claim 11, wherein after insertion of the longitudinal rods, the rims of the receiving depression in mouth regions are pressed at the longitudinal rods.

14. A method according to claim 13, wherein after insertion of the longitudinal rods, the rims of the receiving depressions in their mouth regions are pressed at the longitudinal rods by squeezing.
